(19) United States
(12) Patent Application Publication
(10) Pub. No.: US 2026/0318000 A1
(43) Pub. Date: Oct. 15, 2026

(54) Method for Producing Multi-Angle Image Display Fabrics Through Segment Folding and Linear Stitching Techniques

(71) Applicant: GIOVANNA CRUZ HADDAD, São Paulo (BR)

(72) Inventor: GIOVANNA CRUZ HADDAD, São Paulo (BR)

(21) Appl. No.: 19/174,092

(22) Filed: Apr. 9, 2025

(51) Int. Cl. D06P 5/20; B41M 5/025; B41M 5/035; D06P 7/00

(52) U.S. Cl. CPC D06P 5/20; B41M 5/0256; B41M 5/035; D06P 7/00

(57) ABSTRACT

The present invention relates to a method for producing fabrics capable of displaying distinct images depending on the viewing angle. The method involves dividing a fabric into a series of segments, folding every second segment along a predetermined axis, and sewing a straight line along the folded edges to secure the folds in place. Images are applied to specific portions of the folded and non-folded segments such that different images are visible from varying viewing angles. This process creates a dynamic, optical effect, allowing the fabric to display a first image when viewed from a first angle and a second image when viewed from a second angle. The invention overcomes the limitations of prior art by introducing three-dimensional structural modifications to the fabric, rather than relying solely on flat printing techniques. The resulting fabric has applications in fashion, interior design, advertising, and other industries where interactive textiles are desired.

### BACKGROUND OF THE INVENTION

### Field of the Invention

The present invention relates to methods for manufacturing textiles and fabrics with enhanced visual properties. Specifically, the invention pertains to a method for producing fabrics capable of displaying distinct images depending on the viewing angle, achieved through a novel technique of segment folding and linear stitching. The invention is particularly applicable in the fields of textile manufacturing, fashion design, and optical-display-enhanced materials, and it addresses a need for dynamic and visually interactive fabric designs for garments, accessories, and other textile-based applications.

### BRIEF SUMMARY OF THE INVENTION

The present invention provides a novel method for producing a fabric capable of displaying distinct images depending on the viewing angle. The invention leverages the innovative process of folding every second segment and sewing a straight line, which results in a dynamic optical effect that allows different images to be perceived when the fabric is viewed from varying perspectives. This method introduces a unique way to enhance visual interaction with textiles, distinguishing it from conventional printing and textile fabrication techniques.

The invention improves upon prior art, such as U.S. Pat. No. 8,958,131B2, which discloses methods for printing digital images across the surfaces of clothing articles. Unlike the prior art, which involves transfer of a digital image to be applied to an article of clothing in a manner that prints an entire two-dimensional surface, the present invention introduces a structural modification to the fabric itself, rather than relying solely on printing techniques. By incorporating a folding and stitching method, the present invention enables the creation of three-dimensional effects and distinct image displays that are not limited to flattened surfaces or static images.

This novel method is applicable across various industries, including fashion, interior design, and advanced textiles, offering enhanced aesthetic and functional capabilities. The ability to create fabrics that change visual appearance based on viewing angle represents a significant advancement in the textile and garment manufacturing industry.

### BRIEF DESCRIPTION OF THE FIGURES

FIG. 1: A visual representation of three digitally split images of identical size, divided into equal segments of 94 pixels each.

FIG. 2: A document layout created based on FIG. 1, where the segments from the three images are sequentially arranged in alternating order across the width, resulting in a layout with triple the original width.

FIG. 3: A process diagram illustrating the folding and stitching of every second segment (marked in black) on the printed fabric, producing a final fabric that displays three distinct images depending on the viewing angle.

### DETAILED DESCRIPTION

The present invention relates to a method for producing fabrics capable of displaying distinct images depending on the viewing angle. This unique functionality is achieved through a novel process that involves “folding every second segment and sewing a straight line,” resulting in a three-dimensional structure on the fabric's surface. This invention departs significantly from conventional textile production and image application techniques by introducing structural modifications to the fabric itself, thereby enabling the creation of dynamic optical effects that provide a high level of interactivity and aesthetic appeal.

### Structural Overview and Core Methodology

The invention begins with the selection of a base fabric. This base fabric serves as the foundational material for the process and may be selected based on specific mechanical, optical, or aesthetic properties, depending on the intended application. Examples of suitable materials include natural fibers such as cotton or silk, synthetic fibers such as polyester, or composite materials combining natural and synthetic elements. The selected fabric is divided into a series of segments, with each segment representing a defined portion of the material's surface area. The segmentation process may involve predetermined measurements or patterns, depending on the desired end result.

To create the desired optical effect, “every second segment” of the fabric is folded along a defined axis. The folding may occur in either a uniform or variable manner, depending on the specific optical properties to be achieved. In a uniform configuration, each folded segment is identical in width, length, and angular displacement, whereas a variable configuration may allow for different folding patterns to produce customized image effects. The folds are aligned precisely to maintain consistency across the fabric and to ensure that the final structure is capable of producing distinct images at different viewing angles.

Once the folding process is complete, the folded segments are permanently secured in place using a sewing process. A straight line is sewn along the folded edges of each segment, locking the folded structure into position. The stitching process not only reinforces the structural integrity of the folds but also serves as a key element in preserving the alignment and consistency required to produce the optical effects. The type of stitching used may vary, with options including single-stitch, double-stitch, or decorative stitching, depending on the functional and aesthetic requirements of the fabric.

### Integration of Images and Viewing Angle Effects

The distinct image-display effect is achieved by integrating images into the fabric. This step involves printing, dyeing, or otherwise applying visual content to the fabric in a manner that interacts with the folded structure. The key aspect of this step lies in the spatial arrangement of the images relative to the folds. Portions of the image are strategically placed on different segments of the fabric, such that specific parts of the image are visible only when the fabric is viewed from a certain angle. For example, an image may be divided into two or more complementary portions, with one portion applied to the exposed surfaces of the folded segments and the other portion applied to the recessed surfaces. When viewed from a first angle, only the exposed surfaces are visible, revealing the first portion of the image. When viewed from a second angle, the recessed surfaces become visible, revealing the second portion of the image. The process may be extended to accommodate additional viewing angles, allowing for three or more distinct images to be displayed depending on the angle of observation.

The result of this process is a fabric that exhibits dynamic optical properties, allowing it to display one image when viewed from a first angle and a completely different image when viewed from a second angle. This functionality introduces a level of interactivity and visual complexity that is not achievable with conventional two-dimensional printing techniques.

### Expansion to Other Industries

The present invention is not limited to the field of fashion but encompasses a wide range of potential applications across various industries. Beyond its use in garments, the method can be applied to create textiles or materials intended for interior design, such as curtains, decorative panels, upholstery, and wall coverings. It is also applicable in advertising and marketing, where the optical effects can be used to create dynamic and interactive displays, attracting the attention of potential consumers. These characteristics make the invention a versatile and innovative solution for any area where textiles with dynamic visual effects can add functional or aesthetic value.

For instance, in interior design, the method can be used to create decorative panels that alternate between different patterns or colors depending on the observer's position. In the advertising sector, the fabric can display alternating messages or images that create greater impact in promotional materials. Furthermore, the method can be combined with reflective, luminescent, or transparent materials, expanding its applications to lighting projects or decorative elements with light and shadow interaction.

The invention is also applicable in the automotive industry, where it can be integrated into vehicle interiors such as seat covers, panels, and headliners, enabling customizable visual effects in response to shifting perspectives inside the vehicle. Additionally, the technology sector may benefit from the invention, particularly in the development of interactive electronic accessories such as device covers, cases, or embedded textile displays that change based on user movement. The ability to integrate this method into non-traditional materials, such as composites, polymers, and reflective or light-absorbing materials, further expands its applicability beyond textiles, making it relevant for artistic installations, exhibition displays, and high-end luxury branding.

### Advantages Over Prior Art

The invention represents a significant departure from prior art, such as U.S. Pat. No. 8,958,131B2, which describes methods for “transfer of a digital image... to be applied to an article of clothing in a manner that prints an entire two-dimensional surface.” While the prior art focuses on applying static images to flattened surfaces, the present invention incorporates three-dimensional structural modifications to the fabric itself. Specifically, it involves “folding every second segment and sewing a straight line,” which enables the creation of viewing-angle-dependent image effects. Additionally, the invention eliminates the need for flattening the fabric during the image application process, a limitation noted in the prior art: “Because of the nature of printing techniques, in order to print a surface of a clothing article, the surface generally must be flattened.” By introducing folding and stitching techniques, the present invention overcomes these limitations and introduces a novel method for producing fabrics with dynamic optical properties.

Furthermore, the ability to alternate between multiple images depending on the viewing angle provides functional benefits beyond aesthetic appeal. The method can be adapted for use in contexts where discreet messaging or security coding is required, such as anti-counterfeiting measures, hidden branding elements, or personalized design features that are only visible under specific conditions.

The present invention provides a novel method for producing fabrics that display distinct images depending on the viewing angle. By utilizing the process of “folding every second segment and sewing a straight line,” the invention introduces a three-dimensional structure to the fabric that enables dynamic optical effects. This method represents a significant advancement over conventional textile production and image application techniques, providing enhanced functionality and aesthetic appeal. The invention has wide-ranging applications in fashion, interior design, advertising, automotive interiors, technology, and other industries, offering a versatile solution for creating fabrics with interactive and visually engaging properties. Additionally, the adaptability of the method to non-textile materials such as composites, polymers, and reflective surfaces further enhances its commercial and technological value, opening avenues for future innovation in dynamic visual design.

To optimize the visibility of multiple images while maintaining the structural integrity and flexibility of the fabric, each second segment is folded at an angle between 30° and 70°. This range has been determined to provide the best balance between the distinct visibility of separate images and the practical handling of the material. Folding at angles below this range may result in excessive overlap, reducing the clarity of image differentiation, while angles beyond this range may compromise fabric flexibility and usability.

The folded segments may be secured using visible or concealed stitching, depending on design and functional preferences. Concealed stitching may be used to enhance aesthetic appeal, particularly in applications where seamless integration is desired, such as luxury fashion or high-end interior design. In contrast, visible stitching can serve as a design element or provide additional reinforcement for high-durability applications. Regardless of whether the stitching is exposed or hidden, the essential requirement is that it maintains the structural integrity of the folds, ensuring that the fabric consistently displays distinct images depending on the viewer's angle.

While stitching is a preferred method for securing the folds, the present invention also encompasses alternative fixation methods that achieve the same structural effect. These methods include, but are not limited to, adhesive bonding, heat fusion, ultrasonic welding, and mechanical fastening techniques. The use of adhesives or heat-based bonding methods may be particularly beneficial for non-traditional textile applications, such as composite materials or technical fabrics where stitching may not be feasible. By incorporating multiple fixation techniques, the invention ensures adaptability across a wide range of industries, materials, and manufacturing processes.

The image transition effect achieved through this method is a result of an angular-dependent reflection and occlusion effect. When viewed from a particular angle, the folded segments function as optical barriers, selectively concealing portions of the image while revealing others. This controlled visibility creates the perception of distinct images at different angles. The interaction between light, fabric folds, and the observer's perspective plays a crucial role in producing a seamless transition between images. This principle is similar to lenticular printing but is achieved through fabric manipulation rather than surface coatings or specialized printing techniques, making it unique in its application.

Furthermore, it is important to clarify the sequence of the fabrication process. While the original description may suggest that the fabric is folded before printing, in practice, the image is first printed onto the flat fabric before the segments are folded and stitched. This ensures that the printed image aligns precisely with the designated segments, allowing for accurate positioning when the fabric is later manipulated.

In addition to traditional printing methods, advanced 3D printing technologies may be incorporated into this method to further enhance the fabric's dynamic visual properties. Technologies such as the Stratasys J850 3D printer, which enables direct multi-material and multi-color printing onto fabric, can be leveraged to introduce even more complex image transitions. By printing raised or textured elements with different colors on each side of a folded segment, it becomes possible to achieve even more striking optical effects, expanding the range of possible applications. This integration of 3D-printed surface modifications could allow for hybrid textile structures that combine both color-shifting imagery and textural variations, offering potential innovations in luxury branding, interactive fashion, and immersive design environments.

With these refinements and expansions, the invention further solidifies its broad industrial applicability, providing a robust and adaptable solution for applications in fashion, advertising, interior design, automotive interiors, artistic installations, and cutting-edge 3D-printed textiles.

### DETAILED DESCRIPTION OF FIGURES

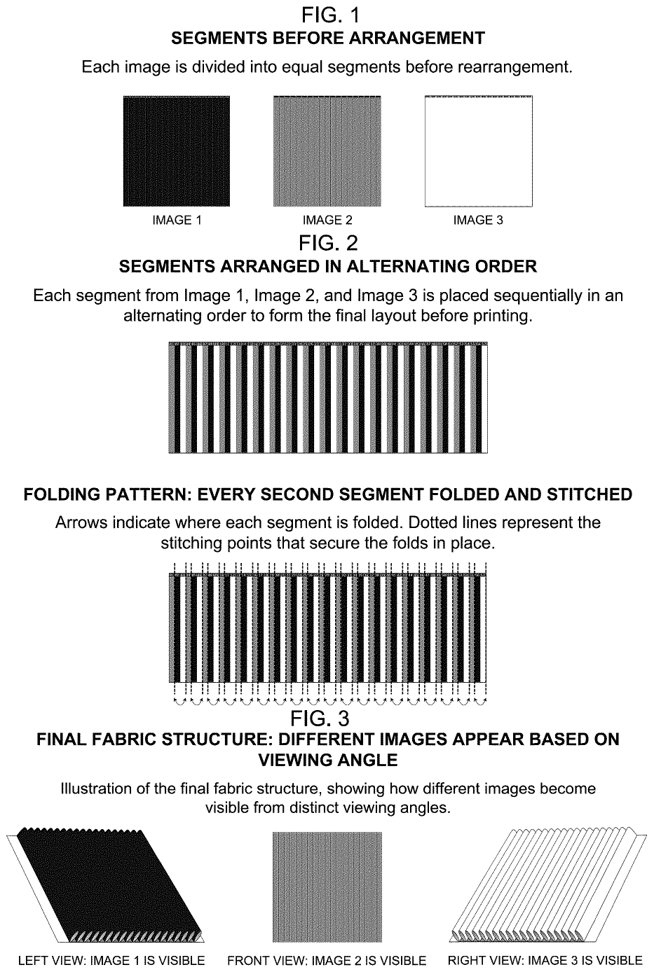

FIG. 1: Illustrates the initial step in the process of creating a fabric capable of displaying distinct images depending on the viewing angle. In this step, three images of identical dimensions are digitally processed. Each image is divided into equal-width vertical segments, with each segment measuring 94 pixels in width. This segmentation divides the images into consistent portions, which are later rearranged to create the final composite image. The process ensures that each segment corresponds precisely to its counterpart in the other images, maintaining alignment for accurate reconstruction of the images when viewed from different angles. This segmentation forms the foundation of the invention by enabling selective visibility of image portions during subsequent fabrication steps.

FIG. 2: Depicts the creation of a document that arranges the segmented portions of the three images from FIG. 1 into a single composite layout. The document has the same height as the original images but a width that is three times greater, accommodating the sequential arrangement of all segments from the three images. The segments are placed in an alternating order across the width of the document: one segment from the first image, followed by one segment from the second image, then one segment from the third image, and so on, until all segments are arranged. This alternation ensures that when the fabric is folded and stitched (as shown in subsequent figures), each viewing angle reveals only the corresponding image segments, producing the desired optical effect. The alignment and spacing of the segments in this document are critical to achieving the final dynamic display functionality of the fabric.

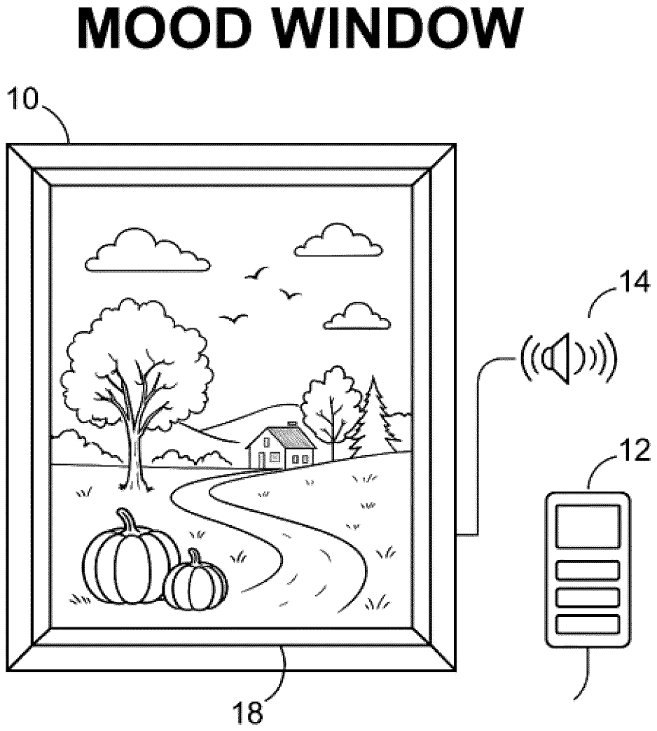

FIG. 3: Demonstrates the final steps in the process, starting with printing the composite image (from FIG. 2) onto a flat piece of fabric. Once the composite image is transferred, the fabric is manipulated to create the structural modifications required for the dynamic image display. Every second segment of the fabric, corresponding to the black-marked areas in the figure, is folded along a predetermined axis. These folds are then secured by sewing a straight line along the folded edges, with one segment left flat between each fold. This alternating fold-and-stitch process is repeated across the entire width of the fabric. The resulting three-dimensional surface topology ensures that only the segments corresponding to one image are visible from a specific viewing angle, while the other segments are either hidden or less visible. As a result, the fabric displays three distinct images, each corresponding to a different angle of observation. This folding and stitching process is the key innovation that enables the optical functionality of the fabric.

### Alternative Implementations—Additive Manufacturing

While the present invention is primarily described in the context of flexible textiles, it is noted that the same angle-dependent visual effect may also be achieved through other manufacturing techniques. In particular, additive manufacturing methods—such as multi-material or multi-color 3D printing—may be employed to produce structures with layered or segmented surfaces that replicate the same optical behavior described herein. These methods could be used to fabricate the arrangement of image segments and viewing-angle effects without requiring folding or stitching.

For example, 3D printing systems capable of depositing materials in precise color zones or layers—such as printers designed to print directly on textiles or flexible substrates—may allow for the generation of similar interactive visual effects through a different fabrication route. This does not replace the core textile-based approach of the invention but rather illustrates its potential for broader applicability across multiple manufacturing platforms.

What is claimed is:

1. A method for producing a fabric capable of displaying distinct images depending on a viewing angle, the method comprising:
a. dividing a fabric into a series of segments along its surface;
b. folding every second segment of the fabric along a predetermined axis to create a folded structure with alternating folded and non-folded segments;
c. sewing a straight line along the edges of the folded segments to secure the folded structure in place;
d. applying a first portion of an image to a first set of surfaces formed by the folded segments;
e. applying a second portion of the image to a second set of surfaces formed by the non-folded segments or recessed surfaces of the folded segments;
f. wherein the resulting fabric is configured to display the first portion of the image when viewed from a first angle and the second portion of the image when viewed from a second angle.

2. The method of claim 1, wherein the folding step comprises folding each second segment at an angle between 10° and 90°, thereby creating a three-dimensional surface topology.

3. The method of claim 1, wherein the stitching step further comprises using a double-stitch technique to reinforce the structural integrity of the folded segments.

4. The method of claim 1, wherein the images are applied to the fabric using a printing technique selected from the group consisting of dye sublimation, digital inkjet printing, screen printing, or heat transfer.

5. The method of claim 1, wherein the images applied to the folded and non-folded segments are configured to alternate between two distinct visual patterns or graphical designs.

6. The method of claim 1, further comprising selecting the fabric from a material selected from the group consisting of natural fibers, synthetic fibers, or composite materials, wherein the material is selected based on its optical and structural properties.

7. The method of claim 1, wherein the folded segments are arranged in a uniform pattern across the fabric, and the alignment of the folds is configured to produce a consistent optical effect.

8. The method of claim 1, wherein the folded segments are arranged in a variable pattern across the fabric, wherein the variable pattern is configured to create customized or localized optical effects.

9. A fabric produced by the method of claim 1, wherein the fabric displays a first image at a first viewing angle and a second image at a second viewing angle, and wherein the images alternate based on the viewing position relative to the fabric.

10. The fabric of claim 9, wherein the fabric is incorporated into an article selected from the group consisting of clothing, upholstery, curtains, wall panels, and signage.

11. The method of claim 1, further comprising incorporating additional structural modifications into the fabric, including pleats, tucks, or embossing, to enhance the visual effects of the image display.

12. The method of claim 1, wherein the viewing angles for distinct image display are controlled by adjusting the spacing, angle, or alignment of the folded segments.

13. The method of claim 1, wherein the fabric includes a coating or treatment to enhance the durability, reflectivity, or optical clarity of the images applied to the fabric.

14. The method of claim 1, wherein the distinct image displays are further enhanced by integrating light-reflective or light-absorptive materials into the folded or non-folded segments of the fabric.

15. A system for producing a fabric capable of displaying distinct images depending on a viewing angle, the system comprising:
a. a segmenting device configured to divide the fabric into a series of segments;
b. a folding apparatus configured to fold every second segment of the fabric along a predetermined axis;
c. a sewing mechanism configured to stitch a straight line along the folded segments;
d. an image application system configured to apply distinct portions of an image to the folded and non-folded segments of the fabric;
e. wherein the system is configured to produce a fabric capable of displaying a first image when viewed from a first angle and a second image when viewed from a second angle.
